(19) United States
(12) Patent Application Publication
(10) Pub. No.: US 2025/0158266 A1
(43) Pub. Date: May 15, 2025

(54) FREQUENCY TUNABLE RESONATOR

(71) Applicant: HUAWEI TECHNOLOGIES CO., LTD., Shenzhen (CN)

(72) Inventors: Nilsánu Johan Pirak Sikku, Kista (SE); Xiaofeng Zhang, Kista (SE)

(73) Assignee: HUAWEI TECHNOLOGIES CO., LTD., Shenzhen (CN)

(21) Appl. No.: 19/025,872

(22) Filed: Jan. 16, 2025

Related U.S. Application Data
(63) Continuation of application No. PCT/EP2022/069986, filed on Jul. 18, 2022.

(51) Int. Cl. H01P 7/10

(52) U.S. Cl. CPC H01P 7/10

(57) ABSTRACT

The present disclosure relates to a frequency tunable resonator comprising a dielectric block having a surface coated with a conductive layer. The frequency tunable resonator further comprises a conductive tuning pattern at the surface of the dielectric block delimited by an opening in the conductive layer. An electrically controllable switch is configured to conductively connect the conductive tuning pattern to a conductive structure. The frequency tunable resonator will therefore resonate at a first frequency (F1) when the electrically controllable switch is operating in its non-active state, and resonate at a second frequency (F2) when the electrically controllable switch is operating in its active state.

### CROSS-REFERENCE TO RELATED APPLICATIONS

This application is a continuation of International Application No. PCT/EP2022/069986, filed on Jul. 18, 2022, the disclosure of which is hereby incorporated by reference in its entirety.

### TECHNICAL FIELD

The present disclosure relates to a frequency tunable resonator e.g., for a filter application in a communication device.

### BACKGROUND

Tunable radio frequency (RF) components are of great interest as an ever-increasing number of frequency bands need to be supported in modern communication system while the demand for miniaturization result in design constraints due to size limitations. Because of these requirements, multiband and/or multi-standard systems are a desirable property in any RF front end components, such as RF filters, in communication devices.

The basic building block of RF filters is so-called resonators which are arranged in such a way to pass an RF signal in a frequency passband while rejecting signals outside of the passband. The resonance frequency of the RF resonators determines the filter passband and by using a number of tunable resonators, a frequency tunable filter can be realized. Tunable filters have the potential to add higher flexibility and support more frequency bands without a significant increase in size by using a single filter with tuning elements able to shift the frequency response of the filter so as to cover a larger range of frequency bands.

There are several desirable properties which tunable resonators need to satisfy to perform well in tunable filters, such as high Q resonators (i.e., low power loss), low power consumption, wide tuning range, fast tuning speed, good linearity, high power handling, and small tuning element footprint (i.e., small size).

Several conventional solutions of tuning filters exist but there are few if any which display many of these desirable properties. This limits the usage of tunable filters in practice.

### SUMMARY

The present disclosure provides solutions that mitigate drawbacks or solve problems of conventional solutions.

The present disclosure provides a resonator solution that is simple to produce and easy to implement in multiple filter applications.

According to an aspect of the present disclosure, a frequency tunable resonator is provided comprising:
a dielectric block comprising a surface coated with a conductive layer,
an input port configured to receive an input signal,
an output port configured to output an output signal,
a resonator arranged inside the dielectric block and being electromagnetically connected to the input and the output, respectively,
at least one dielectric opening in the conductive layer delimiting a conductive tuning pattern at the surface of the dielectric block, and
at least one electrically controllable switch configured to conductively connect the conductive tuning pattern to a conductive structure when operating in its active state; the frequency tunable resonator being configured to:
resonate at a first frequency when the electrically controllable switch is operating in its non-active state, and
resonate at a second frequency when the electrically controllable switch is operating in its active state.

That the electrically controllable switch is in its active state may be understood such that the electrically controllable switch is conductive meaning that an electrical signal can pass through the switch. This is contrary to the case when the electrically controllable switch is in its non-active state in which an electrical signal cannot pass through the switch. The electrically controllable switch can be any type of switch having the suitable properties.

An advantage of the frequency tunable resonator according to the first aspect is that the frequency tunable resonator may be utilized as a building block in any type of filter to realize tunable properties. Further, the present frequency tunable resonator provides a very low profile and small footprint system which is simple to realize on any substrate with existing methods for producing dielectric openings slots in the conductive layer. In addition, the tuning structure herein disclosed can easily be applied to any current or previously designed filters without having to modify the topology or resonator positions significantly. Any type of controllable switch can be used which makes the resonator configurable with regards to switch type depending on performance requirements. The frequency tunable resonator according to the first aspect is easy to modify according to specifications, such as the frequency tuning range, and further the switches are interchangeable depending on priority in reducing insertion loss or increasing switching speed.

In an implementation form of a frequency tunable resonator, the conductive tuning pattern comprises a first conductive section connected to a second conductive section via at least one additional electrically controllable switch.

An advantage with this implementation form is that by adding additional controllable switches, the number of tuning states increases where the number of tuning states achievable is 2ⁿ where n is the number of switches in a certain configuration.

In an implementation form of a frequency tunable resonator, the second conductive section is circumferentially arranged around the first conductive section.

An advantage with this implementation form is that a small incremental tuning step can be implemented without significantly increasing the footprint of the tuning element.

In an implementation form of a frequency tunable resonator, the conductive tuning pattern comprises a single conductive section.

An advantage with this implementation form is that a very simple configuration may be provided for low cost applications.

In an implementation form of a frequency tunable resonator, the conductive tuning pattern is coaxially arranged in relation to the resonator in the dielectric block.

An advantage with this implementation form is that since the tuning pattern is arranged at the point of strongest electromagnetic field, the tunability of the resonator is increased.

In an implementation form of a frequency tunable resonator, the resonator is a resonator cavity comprising an opening extending inwards from the surface of the dielectric block.

In an implementation form of a frequency tunable resonator, the opening of the resonator cavity and the conductive tuning pattern are arranged on opposite surfaces of the dielectric block.

An advantage with this implementation form is that since the tuning pattern is arranged at the point of strongest electrical field, the tunability of the resonator is increased.

In an implementation form of a frequency tunable resonator, the dielectric block has a cubic or a cuboid shape.

In an implementation form of a frequency tunable resonator, the electrically controllable switch is a semiconductor, a variable capacitance, or a variable inductance.

An advantage with this implementation form is that a large number of different components may be used in this respect thereby providing a wider range of design choices.

In an implementation form of a frequency tunable resonator, the electrically controllable switch is mounted at the dielectric block.

An advantage with this implementation form is that the footprint is greatly reduced by mounting the electrically controllable switch at the dielectric block.

In an implementation form of a frequency tunable resonator, the conductive layer is the conductive structure.

An advantage with this implementation form is that the controllable switch can be connected to the conductive ground, eliminating the need for additional structures or components.

In an implementation form of a frequency tunable resonator, the frequency tunable resonator comprises a dielectric layer arranged at the dielectric block, and wherein the electrically controllable switch is mounted at the dielectric layer.

An advantage with this implementation form is that the controllable switches and feed network can be designed without size restrictions of the resonator by shifting the switch reference plane and mounting position to an external dielectric layer/substrate.

In an implementation form of a frequency tunable resonator, the electrically controllable switch is connected to the conductive tuning pattern via a conductive interface.

An advantage with this implementation form is that the controllable switches and feed network can be designed without size restrictions of the resonator by shifting the switch reference plane and mounting position to an external dielectric layer/substrate.

In an implementation form of a frequency tunable resonator, the conductive structure is arranged at the dielectric layer or connected to the dielectric layer.

An advantage with this implementation form is that the controllable switches and feed network can be designed without size restrictions of the resonator by shifting the switch reference plane and mounting position to an external dielectric layer/substrate.

In an implementation form of a frequency tunable resonator, the frequency tunable resonator comprises at least one second resonator, at least one second conductive tuning pattern, and at least one second controllable switch; and wherein the resonator and the second resonator are electromagnetically coupled to each other.

An advantage with this implementation form is that a cascade or an arbitrary arrangement of several resonators can be connected to form a tunable radio frequency filter.

In an implementation form of a frequency tunable resonator, the frequency tunable resonator comprises at least one inner cavity coated with a conductive layer and forming a wall section extending inside the dielectric block and at least partially between the resonator and the second resonator.

An advantage with this implementation form is that the symmetry of a radio frequency is broken and a tunable radio frequency filter can hence be designed.

Further applications and advantages of embodiments of the of the present disclosure will be apparent from the following detailed description.

### BRIEF DESCRIPTION OF THE DRAWINGS

The appended drawings are intended to clarify and explain different embodiments, in which:

FIG. 1 shows a frequency tunable resonator according to an embodiment;

FIG. 2 illustrates a conductive tuning pattern according to an embodiment;

FIG. 3 illustrates a conductive tuning pattern according to a further embodiment;

FIG. 4 illustrates a design geometry of a frequency tunable resonator according to an embodiment;

FIG. 5 illustrates a design geometry of a frequency tunable resonator according to a further embodiment;

FIGS. 6 and 7 show a frequency tunable resonator comprising a dielectric layer according to an embodiment in a top view and in a perspective view;

FIG. 8 illustrates exemplary topologies of a frequency tunable resonator comprising multiple resonators;

FIG. 9 shows a frequency tunable resonator comprising multiple resonators according to an embodiment; and

FIG. 10 show performance results for a frequency tunable filter according to an embodiment.

### DETAILED DESCRIPTION

A main difference between a single band filter and a tunable filter is the addition of tuning elements in the tunable filter. Depending on tuning solution this will have a major impact on the overall system performance of the filter. In particular, tunable filters suffer from low quality (Q) factor values related to losses in the resonator as an effect of added tuning elements. High Q factor resonators can therefore have a severely reduced performance due to the addition of tuning elements. Therefore, the tuning elements should preferably have a small impact on the resonators Q factor.

In addition, while the tuning of cavity filters is a well explored area, the tuning of ceramic block filters is fairly unexplored. Ceramic block filters restrict the choice of tuning elements due to the solid structure of the filter itself. Most tunable filters operate with an air cavity where tuning elements can simply be inserted into the air cavity. This is naturally not possible in ceramic block filters and therefore some of the conventional ways of tuning are physically not feasible.

The present disclosure therefore provides a new solution of tuning ceramic block resonators which achieves a good compromise between the desired requirements for tunable filters by a new type of tunable resonator structure. Among other things, miniaturized tunable filters may therefore be realized. In ceramic block filters the previous tunable solutions have been based on mechanical tuning with slow tuning speed or varactors with low Q factor. The solution herein presented instead utilizes controllable switches which eliminates the need for low Q factor varactors while still providing fast response time. Further, the present frequency tunable resonator can be optimized with regards to loss and tuning speed based on component choice.

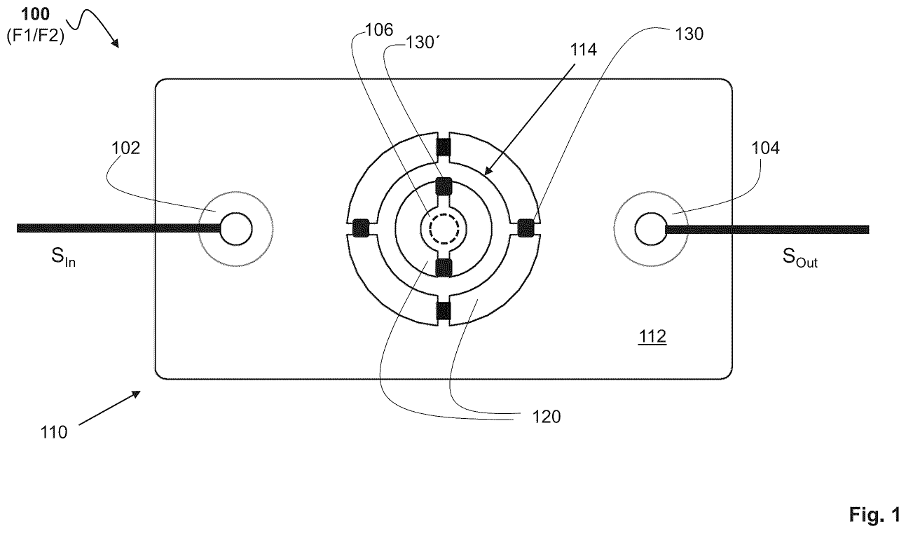

FIG. 1 shows a frequency tunable resonator 100 seen in a view from above. The frequency tunable resonator 100 comprises a solid dielectric block 110, such as a high Q ceramic with a large relative permittivity, which in turn comprises a surface coated with a conductive layer 112. The frequency tunable resonator 100 further comprises an input port 102 configured to receive an input signal S_{In}, and an output port 104 configured to output an output signal S_{Out}. The output signal S_{Out} is a processed input signal S_{In}. The input signal S_{In} and the output signal S_{Out} may comprise high frequency signals such as RF signals and such RF signals may be used as communication signals in different types of communication systems.

The frequency tunable resonator 100 further comprises a resonator 106 (illustrated with dashed lines) arranged inside the dielectric block 110 and being electromagnetically connected to the input 102 and the output 104, respectively. The resonator 106 may as shown in FIG. 1 be a resonator cavity filled with air. However, the resonator 106 herein used does not need to be a resonator cavity. The resonator 106 may. e.g., in other example refer to the dielectric block itself without additional structures and may utilize other propagation modes than the fundamental mode.

The frequency tunable resonator 100 further comprises at least one dielectric opening 120 in the conductive layer 112 delimiting a conductive tuning pattern 114 at the surface of the dielectric block 110. The frequency tunable resonator 100 further comprises at least one electrically controllable switch 130, 130′ configured to conductively connect the conductive tuning pattern 114 to a conductive structure 112 when operating in its active state. The frequency tunable resonator 100 is hence configured to: resonate at a first frequency F1 when the electrically controllable switch 130 is operating in its non-active state, and resonate at a second frequency F2 when the electrically controllable switch 130 is operating in its active state. The first frequency F1 is different to the second frequency F2, hence a tunable resonator is provided.

The dielectric block 110 may be moulded or produced in any other suitable way. The dielectric block 110 may be a ceramic dielectric block encased in a conductive coating such as silver or copper coating. However, any other dielectric substrate and conductor can be used as a dielectric block with the same effect. The dielectric block 110 is designed so as to resonate at a desired design frequency or frequencies. The dielectric block 110 can have any shape and with any internal structures present without affecting the basic functionality of the herein disclosed resonator solution.

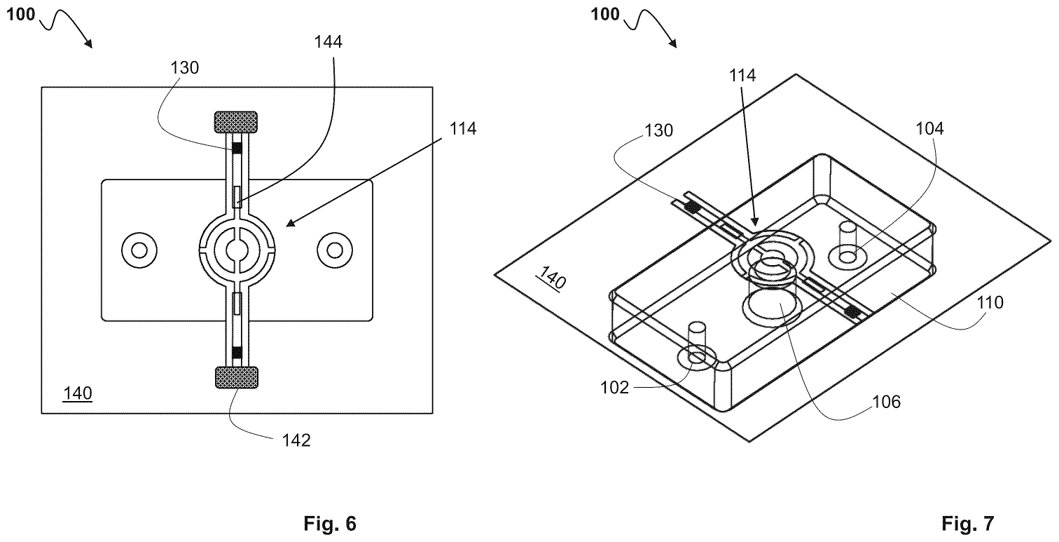

In embodiments, the conductive layer 112 is the conductive structure itself. This implies that the conductive layer 112 in this case act as a ground of the resonator 100 and is interrupted by dielectric openings 120 in the conductive layer 112. By introducing a direct ceramic-to-dielectric interface in the form of dielectric openings 120 in the conductive layer 112, the electrical property of the resonator 100 is changed with the perturbation of the internal electrical fields. The dielectric openings 120 in the conductive layer 112 form and define a conductive tuning pattern 114, where a point located on the conductive layer 112 is separated from another point on the conductive layer 112 by a dielectric opening in the conducting ground. Both points may still be connected to the conductive layer 112 and the ground plane of the resonator 100. By this separation, a surface current has to use a different path through the conductive layer 112 to connect the two points. One or more of these points may be electrically connected to a conducting ground not part of the conductor casing. This conducting ground may be mounted on a dielectric substrate which in turn may be connected to one or more controllable switches 130. Thereby, a new electrical path is introduced for the surface current on the conductive layer 112 and electromagnetic coupling between the internal electrical fields of the resonator 100. The electrical path may be connected to a common ground separated by a controllable switch 130. The embodiment using dielectric substrate is described with reference to FIGS. 6 and 7.

The introduction of an alternative electrical path from the conductive layer 112 to an external tuning element allows for a change of capacitance seen by the resonator 100 by a choice of controllable switches 130 and conductive tuning pattern 114. The change of capacitance is an effect perturbing the internal electrical field. The resonance frequency of the resonator 100 can thus be changed in a predictable and controllable way by changing the properties of the external conductor path, e.g., by the closing or opening of one or more controllable switches 130 which connects the external conductor to the ground plane.

An additional advantage of the present resonator structure compared to conventional solutions is that by using conventional readily available RF controllable switches a fast switching speed tuning network can be realized. By utilizing controllable switches for tuning, instead of capacitor banks or variable capacitors, the negative impact of the tuning elements is reduced, especially in the off-state of the controllable switch, i.e., when the controllable switch is not conductive. Hence, embodiments comprise controllable switches 130 and the basic functionality of the frequency tunable resonator 100 does not change with the choice of controllable switch. Therefore, the electrically controllable switch 130 may be any suitable controllable switch known in the art. For example, a semiconductor, a variable capacitance, or a variable inductance.

In embodiments, and also disclosed in FIG. 1, the electrically controllable switch 130 may be directly mounted at the dielectric block 110. However, the electrically controllable switch 130 may in other proposed embodiments be arranged at a dielectric layer separate from the dielectric block 110 which will be described in detail with reference to FIGS. 6 and 7 in the following disclosure.

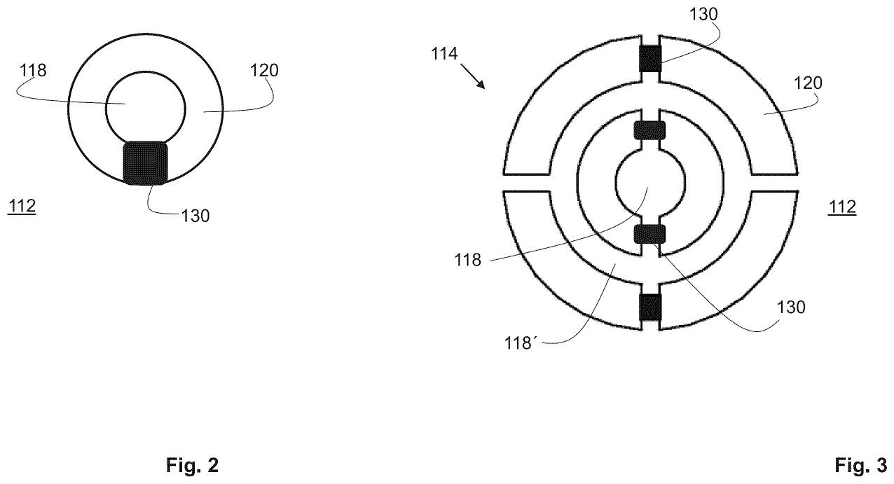

FIG. 2 illustrates a conductive tuning pattern 118 seen from above. In the disclosed example, the conductive tuning pattern 118 comprises of a single conductive section 118. A controllable switch 130 is arranged between the single conductive section 118 and the surroundings conductive layer 112 in a section that hereinafter may be denoted a bridge section since this section bridges the conductive section 118 to the surrounding conductive layer 112. The single conductive section 118 is delimited or defined by the opening 120 in the conductive layer 112. The controllable switch 130 may be operated in an active state (i.e., conductive) or in a non-active state (i.e., non-conductive). Depending on whether the surface current can pass or not pass the controllable switch 130, the frequency passband of the resonator 100 will change thereby providing the tunable resonator functionality as previously described.

FIG. 3 illustrates a conductive tuning pattern 114 which instead comprises a plurality of conductive sections. In this example, the conductive tuning pattern 114 comprises a first conductive section 118 connected to a second conductive section 118′ via at least one additional electrically controllable switch 130. The example in FIG. 3 comprises four controllable switches 130, where two controllable switches 130 connects the first conductive section 118 to the second conductive section 118′, while two other controllable switches 130 connects the second conductive section 118′ to the surrounding conductive layer 112 via bridge sections. As also shown in FIG. 3, the second conductive section 118′ may be circumferentially arranged around the first conductive section 118 so as to fully enclose the latter at the surface of the dielectric block 110.

However, it is realised that the present conductive tuning pattern 114 may comprise any number of conductive sections 118 connected via one or more electrically controllable switches at bridge sections to achieve suitable frequency tuning properties. Hence, depending on the number of conductive sections 118, the shape of the conductive sections 118, the interconnecting structure, number of controllable switches 130, the location of the controllable switches 130, etc. a huge number of different frequency configurations may be provided. Thus, unlimited number of different frequency passbands F1, F2, . . . , Fn may be configured using the present solution.

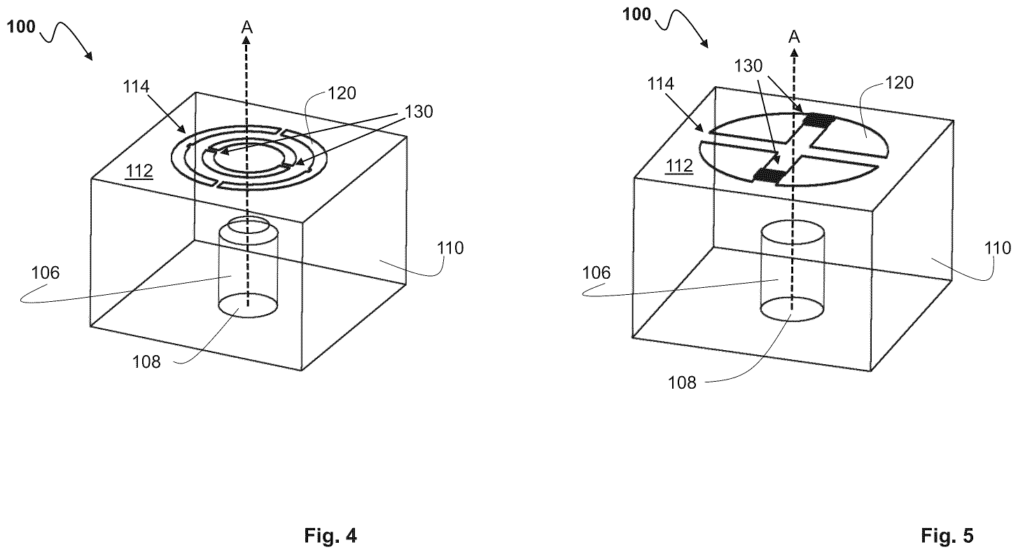

Furthermore, FIG. 4 illustrates a geometry of a frequency tunable resonator 100 shown in a perspective view. FIG. 5 on the other hand illustrates a frequency tunable resonator 100 with a slightly different geometry compared to the one shown in FIG. 4. In these examples, the controllable switches 130 are surface mounted directly on the dielectric block 110. Even with two bridge sections directly connected to the ground the controllable switches 130 introduce a shift in resonance frequency. This means that any arbitrary shape is realizable as long as at least one controllable switch 130, acting as a tuning element, and a conductive tuning pattern 114 is present.

In FIG. 4, the conducting pattern 114 comprises of an inner conductive section enclosed by an outer conductive section. The inner and outer conductive sections are delimited by openings in the conductive layer 112 and connected to each other by means of two controllable switches 130 such that the surface current can flow in two different ways depending on the state of the two controllable switches. The added structure compromises of openings 120 in the conductive layer 112, exposing the internal electromagnetic fields to an interface between the dielectric block 110 and the surrounding air. The openings 120 in the conductive layer 112 may be obtained with any milling process or manually. The bridge sections connecting the middle conductive section to ground is also shown, displaying the principle behind connecting two separate points on the conductive layer. It is clear from the FIGS. 4 and 5 that the electrical path is changed with the opening or closing the controllable switches 130. In FIG. 5, the conducting pattern 114 comprises of a single conductive section which also is delimited to the surrounding conductive layer 112 by openings 120 in the conductive layer. The single conductive section is connected to the surrounding conductive layer 112 via four bridge sections. Two controllable switches 130 are arranged at two of the bridge sections.

In both examples shown in FIGS. 4 and 5, the conductive tuning pattern 114 is coaxially arranged in relation to the resonator cavity 106 in the dielectric block 110. This may be understood such that both the conductive tuning pattern 114 and the resonator cavity 106 are symmetrically arranged around an axis A extending through the dielectric block 110. The axis may be defined as a centre axis as shown in the examples, but may in non-shown examples be dislocated or offset from a centre of the dielectric block 110.

Furthermore, common for both disclosed examples in FIGS. 4 and 5 are that the resonator cavity 106 comprises an opening 108 extending inwards from the surface of the dielectric block 110. It may also be noted that the opening 108 of the resonator cavity 106 and the conductive tuning pattern 114 are arranged on opposite surfaces of the dielectric block 110. The resonator cavity 106 is coated inside with a conductive layer for providing suitable conductive properties. In the disclosed examples in FIGS. 4 and 5, the dielectric block 110 has a substantial cubic or a cuboid shape. However, the general shape of the dielectric block 110 may vary depending on the application. This is also true for the shape of the resonator cavity 106.

FIGS. 6 and 7 show a frequency tunable resonator 100 comprising an additional dielectric layer 140 in a top view (FIG. 6) and in a perspective view (FIG. 7), respectively. The frequency tunable resonator 100 comprises a dielectric layer 140 that is arranged at the dielectric block 110. The dielectric layer 140 may be a so-called PCB layer or any other suitable dielectric layer. The dielectric layer 140 may comprise conductors. The separate dielectric layer 140 may be attached to the dielectric block 110 using soldering, adhesive, or any other suitable attachment technique. The electrically controllable switch 130 is in these examples mounted at the dielectric layer 140 instead of being directly mounted at the dielectric block 110 as previously shown. The controllable switch 130 may be attached to either side of the dielectric layer 140, i.e., either on the surface of the dielectric layer 140 directed towards the dielectric block 110 or the surface of the dielectric layer 140 directed in the opposite direction away from the dielectric block 110.

Further, a conductive structure 142 may be arranged at the dielectric layer 140 or connected to the dielectric layer 140. Moreover, the electrically controllable switch 130 may be connected to the conductive tuning pattern 114 via a conductive interface 144 as also shown FIGS. 6 and 7. The connection between dielectric layer 140 and the conductive tuning pattern 114 by overlapping conductors allows the controlling of the frequency of the resonator 100 via the controllable switches 130.

By using a dielectric layer 140, the controllable switches 130 can be removed from direct connection with the resonator ground. The shift in reference plane for the controllable switches 130 by the connection of the dielectric layer 140 to the tuning pattern is also disclosed. The controllable switches 130 will act as an opening and closing connection between the ground of the dielectric layer 140 and the conductive tuning pattern 114. The ground of the dielectric layer 140 is stacked on top of the ground of the resonator ground. Input 102 and output 104 ports are also shown in FIGS. 6 and 7.

The configuration as disclosed in FIGS. 6 and 7 allows for a great flexibility regarding the placement of the controllable switches 130. By shifting the tuning elements away from a surface mounted setup on top of the conductive filter coating an easier mounting process and higher flexibility in resonator designs are allowed. Also, a signal feed network (not shown) can easily be implemented in the resonator 100 as the space constraints of directly mounted controllable switches is eliminated by the use of the dielectric layer 140. The signal feed network is configured to close/open or activate/deactivate the controllable switches 130 and may also be configured to feed and/or bias the controllable switches 130. The shift in reference plane for the controllable switches 130 however introduce a small insertion loss compared to when the controllable switches 130 are directly mounted at the dielectric block 110. On the other hand, the configuration with dielectric layer 140 allows for choosing components without strict size and space constraints of the resonator 100 comprising the dielectric layer 140. Optimizing the resonator 100 by choice of controllable switches is therefore simplified. Further, a shift in centre frequency is introduced as the dielectric-to-air interface is replaced by a dielectric-to-dielectric interface and can be re-optimized for shifting back the centre frequency. The tuning range of the resonator 100 can also be increased by the introduction of the dielectric layer 140 due to a wider range of switching selection as well as by changing the tuning pattern.

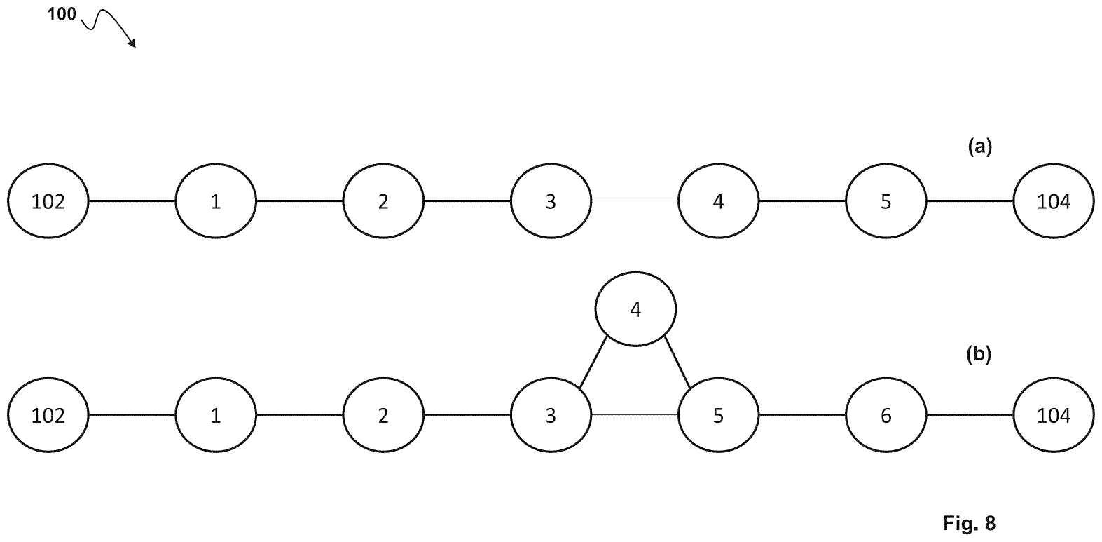

FIG. 8 illustrates a system topology of a frequency tunable resonator 100 comprising multiple resonator cavities connected to each other, where (a) displays a 5-pole straight inline filter structure, while (b) displays a 6-pole filter structure with a triplet section producing a transmission zero. The different resonator cavities are shown as circles and are numbered from 1-5 in (a) or 1-6 in (b) and are arranged between the input 102 and the output 104 of the frequency tunable resonator 100. The electromagnetic couplings between the resonator cavities are illustrated with the lines connecting the circles. The 5-pole straight inline structure illustrates a very simple setup with symmetric tuning elements. The 6-pole on the other hand illustrates a system topology where resonator cavities may be geometrically offset in relation to a straight line or row. Both examples can be implemented with a dielectric layer 140 as previously discussed.

In general terms, the frequency tunable resonator 100 for multi resonator applications comprises at least one second resonator 106′, at least one second conductive tuning pattern 114′, and at least one second controllable switch 130′. The resonator 106 and the second resonator 106′ are electromagnetically coupled to each other. The frequency tunable resonator 100 can thus be realized by cascading an arbitrary number of resonator cavities in an arbitrary configuration with electromagnetic coupling therebetween. The design method for manufacturing multi-pole resonators may not differ to traditionally synthesized and designed filters in the sense that a basic ceramic filter can be designed to introduce the tuning elements, i.e., controllable switches 130, in a last manufacturing step. Therefore, adding controllable switches 130 to already existing ceramic block filter designs is simple to implement. Tuning of open and closed switch positions can be simplified by choosing certain symmetries.

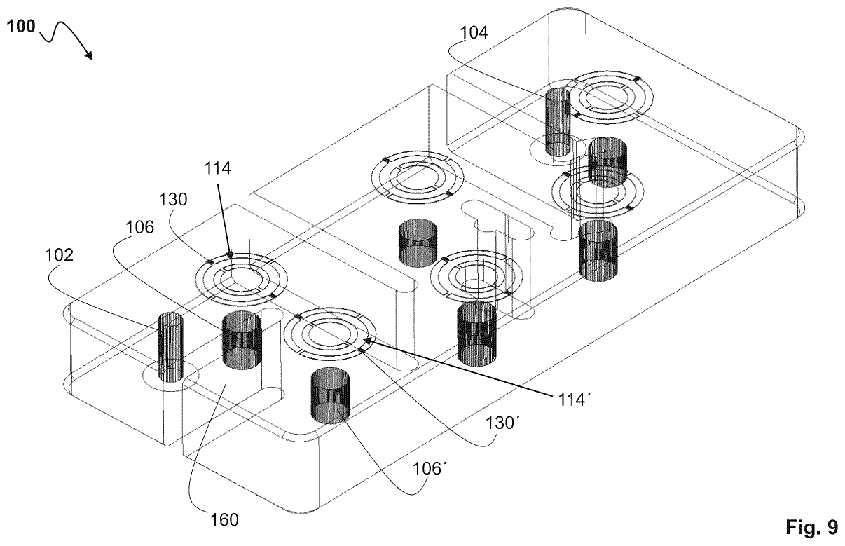

FIG. 9 shows a frequency tunable resonator 100 comprising multiple resonators as illustrated in the system architecture of FIG. 8(b). The frequency tunable resonator 100 comprises six interconnected resonator cavities arranged between the input 102 and the output 104 of the resonator 100. The resonator cavities 106, 106′ are in this particular example arranged in a single dielectric block. To achieve the electromagnetic coupling between different resonator cavities, the frequency tunable resonator 100 may further comprise at least one inner cavity 160 coated with a conductive layer and forming a wall section extending inside the dielectric block 110. Such wall section will aid to guide the electromagnetic coupling between the resonator cavities of the multiple cavity resonator 100. This is especially the case when the layout of the resonator cavities is not arranged in a straight line or row. The tuning range of a resonator 106 can be adjusted by modifying the dimension and shape of the conductive tuning pattern 114. Each subsequent conductive tuning pattern 114′ can be individually modified to achieve the desired tuning range for each corresponding resonator 106′.

In this configuration there are two controllable switches 130 per resonator 106. However, any number of controllable switches 130 can be used without deviating from the scope of the present disclosure. The controllable switches 130 may be controlled electrically for example by a signal feed network sending control signals and/or biasing current to change the state of the controllable switches. The signal feed network may e.g., comprise a microcontroller or a central processing unit (CPU), control lines, etc. Further, in other configurations, the present frequency tunable resonator 100 may comprise one conductive tuning pattern 114 interacting with multiple resonators, etc.

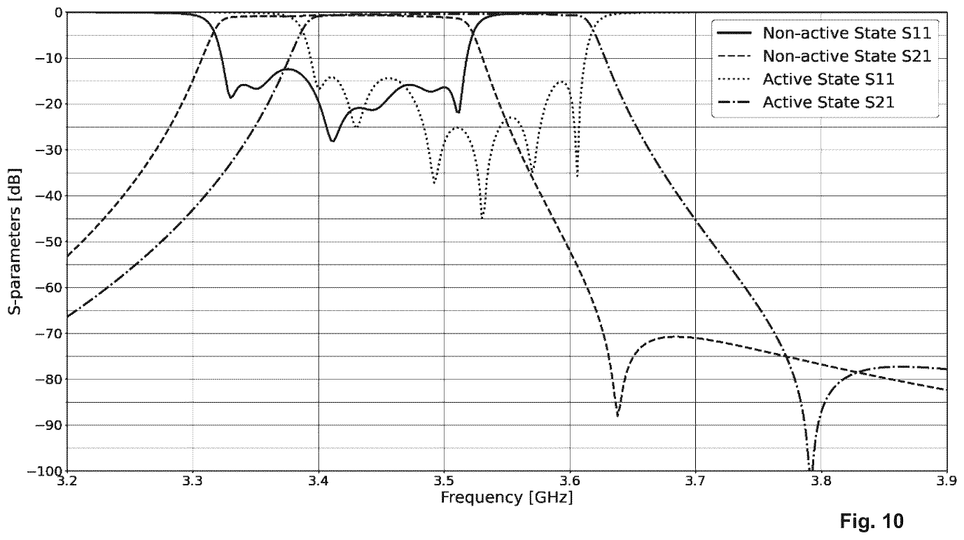

FIG. 10 displays the simulated response of a ceramic passband filter comprising resonators with a designated centre frequency of 3.5 GHz and 200 MHz bandwidth (Active State) and a second passband at 3.4 GHz (Non-active State) for the same filter structure as shown in FIG. 9. The x-axis shows frequency in GHz and the y-axis shows the scattering parameters in dB. The upper passband displays the filtering characteristics of the structure for an active switch state whereas the lower passband displays the response of the filter in a non-active switch state displaying the principle of a tunable filter consisting of a number of tunable resonators 100. The increased mismatch in the lower passband can in part be attributed to the absolute bandwidth being kept constant over the tuning range.

The frequency tunable resonator 100 may be implemented and used in a number of different applications. A non-limiting example is in a communication device and a communication equipment configured for different communication system, such as 3GPP 5G, WiFi, etc. The communication device and communication equipment may e.g., be a part of a network access node or a client device.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station (STA), which is any device that contains an IEEE 802.11-conformant media access control (MAC) and physical layer (PHY) interface to the wireless medium (WM). The UE may be configured for communication in 3GPP related long term evolution (LTE), LTE-advanced, fifth generation (5G) wireless systems, such as new radio (NR), and their evolutions, as well as in IEEE related Wi-Fi, worldwide interoperability for microwave access (WiMAX) and their evolutions.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access nodes may be of different classes or types such as e.g., macro eNodeB, home eNodeB or pico base station, based on transmission power and thereby the cell size. The radio network access node may further be a station (STA), which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

Finally, it should be understood that the disclosure is not limited to the embodiments described above, but also relates to and incorporates all embodiments within the scope of the appended claims.

What is claimed is:

1. A frequency tunable resonator, comprising:
a dielectric block comprising a surface coated with a conductive layer,
an input port configured to receive an input signal,
an output port configured to output an output signal,
a resonator arranged inside the dielectric block and being electromagnetically connected to the input port and the output port,
at least one dielectric opening in the conductive layer delimiting a conductive tuning pattern at the surface of the dielectric block, and
at least one electrically controllable switch configured to conductively connect a conductive tuning pattern to a conductive structure when operating in its active state,
wherein the frequency tunable resonator is configured to:
resonate at a first frequency when the electrically controllable switch is operating in its non-active state, and
resonate at a second frequency when the electrically controllable switch is operating in its active state.

2. The frequency tunable resonator according to claim 1, wherein the conductive tuning pattern comprises a first conductive section connected to a second conductive section via at least one additional electrically controllable switch.

3. The frequency tunable resonator according to claim 2, wherein the second conductive section is circumferentially arranged around the first conductive section.

4. The frequency tunable resonator according to claim 1, wherein the conductive tuning pattern comprises a single conductive section.

5. The frequency tunable resonator according to claim 1, wherein the conductive tuning pattern is coaxially arranged in relation to the resonator in the dielectric block.

6. The frequency tunable resonator according to claim 1, wherein the resonator is a resonator cavity comprising an opening extending inwards from the surface of the dielectric block.

7. The frequency tunable resonator according to claim 6, wherein the opening of the resonator cavity and the conductive tuning pattern are arranged on opposite surfaces of the dielectric block.

8. The frequency tunable resonator according to claim 1, wherein the dielectric block has a cubic or a cuboid shape.

9. The frequency tunable resonator according to claim 1, wherein the electrically controllable switch is a semiconductor, a variable capacitance, or a variable inductance.

10. The frequency tunable resonator according to claim 1, wherein the electrically controllable switch is mounted at the dielectric block.

11. The frequency tunable resonator according to claim 10, wherein the conductive layer is the conductive structure.

12. The frequency tunable resonator according to claim 1, wherein the frequency tunable resonator comprises a dielectric layer arranged at the dielectric block, and wherein the electrically controllable switch is mounted at the dielectric layer.

13. The frequency tunable resonator according to claim 12, wherein the electrically controllable switch is connected to the conductive tuning pattern via a conductive interface.

14. The frequency tunable resonator according to claim 12, wherein the conductive structure is arranged at the dielectric layer or connected to the dielectric layer.

15. The frequency tunable resonator according to claim 1, further comprising:
at least one second resonator;
at least one second conductive tuning pattern; and
at least one second controllable switch,
wherein the resonator and the at least one second resonator are electromagnetically coupled to each other.

16. The frequency tunable resonator according to claim 15, wherein the frequency tunable resonator comprises at least one inner cavity coated with a conductive layer and forming a wall section extending inside the dielectric block and at least partially between the resonator and the second resonator.
